(19) United States
(12) Patent Application Publication
(10) Pub. No.: US 2025/0378283 A1
(43) Pub. Date: Dec. 11, 2025

(54) GENERATIVE AI WITH LOGICAL REASONING

(71) Applicant: NVIDIA CORPORATION, Santa Clara, CA (US)

(72) Inventor: Kalyanasundaram Krishnamani, Santa Clara, CA (US)

(21) Appl. No.: 18/736,332

(22) Filed: Jun. 6, 2024

(51) Int. Cl. G06F 40/58; G06F 16/242; G06F 40/186

(52) U.S. Cl. CPC G06F 40/58; G06F 16/243; G06F 40/186

(57) ABSTRACT

Systems and methods are disclosed related to generative AI with logical reasoning. For example, an LLM may be used to convert statements such as natural language statements or lines of software code into logical statements in a logic specification language, a logical reasoning engine may be used to evaluate the logical statements, and an LLM may be used to explain the output of the logical reasoning engine in natural language (e.g., using a system that uses retrieval augmented generation (RAG) and/or a fine-tuned LLM). As such, the present techniques may be utilized to provide a generative AI system that can logically reason about, deduce new facts from, compute logical consequences of, and/or check the consistency of a set of statements such as natural language statements or software code, and provide a logical explanation of how the computation(s) were done.

### BACKGROUND

Existing large language models (LLMs) like generative pre-trained transformers (GPT) and other generative artificial intelligence (AI) systems are primarily built using deep learning architectures that process and generate responses based on patterns identified from vast datasets. Generative models have become adept at recognizing and replicating patterns, which allows them to generate human-like text by predicting the most likely next word or phrase in a sequence. This approach effectively incorporates analogy-based reasoning, where decisions are made based on similarity scores that quantify similarity between vector embeddings of words in queries and corresponding embeddings of example words learned from the training data. This type of reasoning allows these models to perform well on tasks that model language understanding based on patterns encountered in training data. However, the use of analogy-based reasoning can cause hallucinations, for example, when similarity scores do not adequately represent logic, or when similar words occur in different contexts (e.g., river bank vs. private bank vs. cache bank vs. race-track bank).

By contrast, logical reasoning relies on formal rules of logic and structured thinking to deduce new information or solve problems. This form of reasoning requires an understanding of causal relationships, an ability to apply abstract rules in new situations, and an ability to generate conclusions that are logically consistent with a given premise. Existing LLMs struggle with true logical reasoning because they do not inherently understand or model causality, as the similarity scores they rely on often do not represent logical consequence or equality. As a result, conventional LLMs cannot accurately engage in deductive thinking, reason about generated content or facts that are not explicitly stated in a natural language input, or deduce the logical consequences of a natural language input. For example, conventional LLMs struggle with logic puzzles, and often fail to recognize facts that can be deduced from an input prompt. Some existing research products have performed logical reasoning on math, geometry, or lemmas, but those products cannot perform logical reasoning on statements like those appearing in natural language or software. For example, some existing techniques use an LLM to invoke a theorem solver for mathematics or geometry, but those techniques do not attempt to—and cannot—understand or reason about natural language. Furthermore, existing theorem solvers typically require expertise (e.g., providing axioms when prompted) that is beyond the skill of most users.

The limitations of generative AI in logical reasoning pose significant challenges, particularly in contexts such as those in the legal, medical and health care, financial services, and code generation fields (e.g., for safety-critical software) where the stakes are often high and/or in which decisions require precision and explainability. More specifically, existing generative AI systems like conventional LLMs that rely on pattern recognition cannot easily trace and explain the rationale behind their decisions. This lack of transparency is problematic in fields like the legal and medical fields, in fields governed by regulations, and/or in any field in which professionals need to understand the basis of decisions to ensure they align with ethical standards and/or regulatory requirements. For example, in the context of a medical diagnosis, a clinician must be able to understand why an LLM recommended a particular treatment to evaluate its appropriateness for a patient. In legal contexts where decisions must be justified by legal precedents or statutes, an LLM's inability to logically reason can lead to outputs that might seem to fit well with observed patterns, but nevertheless fail to adequately consider an applicable law, which can result in recommendations that are inappropriate or even unlawful. The inexplicability of LLM-implemented code generation can be problematic, particularly in applications with critical safety requirements like avionics or medical devices, because it hinders the ability to verify and validate safety and operational requirements and can complicate troubleshooting and maintenance. In another example, the opacity can raise issues in the context of financial services since financial decisions often require transparency and justification, and the inability to explain why a trading algorithm executed specific trades can lead to regulatory compliance issues and an inability to identify and correct mistakes. Overall, the inability of existing generative AI systems to perform logical reasoning and explain their decision-making process complicates their deployment in professional settings where decision integrity, explicability, reproducibility, and adherence to specific rules and ethical standards are paramount. As such, there is a need for generative AI systems that can logically reason about statements such as those appearing in natural language or software code.

### SUMMARY

Embodiments of the present disclosure relate to generative AI with logical reasoning. For example, an LLM may be used to convert statements such as natural language statements or lines of software code into logical statements in a logic specification language, a logical reasoning engine may be used to evaluate the logical statements, and an LLM may be used to explain the output of the logical reasoning engine in natural language. In contrast to conventional systems, such as those described above, the present techniques may be utilized to provide a generative AI system that can logically reason about, deduce new facts from, compute logical consequences of, and/or check the consistency of a set of statements such as natural language statements or software code, and provide a logical explanation of how the computation(s) were done.

As such, generative AI systems may use logical reasoning capabilities to evaluate natural language, software, and/or other types of inputs, and logical assessments may be formulated and returned in natural language. As a result, unlike conventional techniques, the present techniques not only provide a way for LLMs and other generative AI systems to logically reason about statements like natural language input statements or lines of code, they also provide explainability (e.g., reasoning, rationale, etc.) for the logical assessments. Accordingly, the present techniques may be used to provide transparency in decision making in contexts such as those in the legal, medical, financial services, and code generation fields, where functional safety standards and/or requirements are high or decisions require precision and explainability.

### BRIEF DESCRIPTION OF THE DRAWINGS

The present systems and methods for generative AI with logical reasoning about natural language are described in detail below with reference to the attached drawing figures, wherein:

FIG. 1 is an illustration of an example logical reasoning system, in accordance with some embodiments of the present disclosure;

FIG. 2 is a data flow diagram illustrating a method for generating a natural language response based on one or more logical assessments of one or more statements, in accordance with some embodiments of the present disclosure;

FIG. 3 is a data flow diagram illustrating a method for generating a natural language response based on one or more logical assessments of time-series data, in accordance with some embodiments of the present disclosure;

FIG. 4A is a block diagram of an example generative LLM system suitable for use in implementing some embodiments of the present disclosure;

FIG. 4B is a block diagram of an example generative LLM that includes a transformer encoder-decoder suitable for use in implementing some embodiments of the present disclosure;

FIG. 4C is a block diagram of an example generative LLM that includes a decoder-only transformer architecture suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to generative AI with logical reasoning. For example, an LLM may be used to convert statements such as natural language statements or lines of software code into logical statements in a logic specification language, a logical reasoning engine may be used to evaluate the logical statements, and an LLM may be used to explain the output of the logical reasoning engine in natural language (e.g., using a system that uses retrieval augmented generation (RAG) and/or a fine-tuned LLM). Unlike prior techniques, the present techniques may be utilized to provide a generative AI system that can logically reason about, deduce new facts from, compute logical consequences of, and/or check the consistency of a set of statements such as natural language statements or software code, and provide a logical explanation of how the computation(s) were done.

In some embodiments, a logical reasoning engine uses mathematical logic to reason about natural language, software, or other types of statements. In order to convert (e.g., natural language, software, etc.) into a format the logical reasoning engine understands, an LLM may be prompted to convert one or more (e.g., natural language, software, etc.) statements into a logical representation in a logic specification language such as Thousands of Problems for Theorem Provers (TPTP). In some embodiments, an LLM (e.g., a pre-trained or foundational LLM) may be tuned (e.g., fine-tuned, prompt tuned, p-tuned, using few-shot learning, using transfer learning, using a retrieval augmented prompt), adapted, or otherwise generated to convert from a first language (e.g., a natural language such as English, a programming language) into a format specified by the logic specification language. For example, an LLM may be fine-tuned using a dataset that associates one or more sets of statement(s) in the first language with corresponding one or more sets of (e.g., first-order and/or higher-order) logical statement(s) (e.g., in TPTP format). As such, a (e.g., first language such as natural language) prompt provided by a user may be inserted into one or more template prompts that instruct the (e.g., fine-tuned) LLM to convert the content of the prompt (e.g., natural language statements, a section of software code) into corresponding (e.g., first-order and/or higher-order) logical statement(s) in the format specified by the logic specification language.

The logical statement(s) may be provided to a logical reasoning engine such as a theorem prover or satisfiability modulo theories (SMT) solver, and the logical reasoning engine may use any known technique to process the logical statement(s) to generate one or more logical assessments (e.g., deducing new facts that are not explicitly stated in a natural language input, applying logical rules to prove or refute a conjecture that was converted from a corresponding query in a natural language prompt, performing a consistency check of the logical statement(s), etc.). The logical reasoning engine may output a representation of its logical assessment(s) (e.g., a set of logical statements representing a proof or refutation) in a logic specification language, which may be the same logic specification language accepted as input.

In some embodiments, an LLM may be used to convert the logical assessment(s) of the logical reasoning engine into the first language (e.g., natural language). For example, logical statement(s) representing the logical assessment(s) output by the logical reasoning engine may be inserted into one or more template prompts that instruct the LLM to explain the logical statement(s) in natural language. In some embodiments, the LLM may be tuned or otherwise adapted to convert the format used by output of the logical reasoning engine (e.g., expressed as a logic specification language) into natural language. For example, explanations about the logic specification language or theorem proving may be encoded into a knowledge database (e.g., a vector database such as VectorDB or Chroma), retrieval augmented generation may be used to augment the prompt using information encoded in the knowledge database, and the retrieval augmented prompt may be provided to the LLM to prompt the LLM to explain the logical statement(s) generated by the logical reasoning engine. As such, a natural language explanation or an answer to a question may be provided to the user.

The present techniques may be used in a variety of applications and use cases. For example, a chatbot may use the present techniques to logically reason about, deduce new facts from, compute logical consequences of, and/or check the consistency of a set of natural language statements or software code provided in one or more input prompts or generated by the chatbot (e.g., explaining why it generated a particular output). In some embodiments, the chatbot may accept one or more statements and a query related to the statement(s), and the chatbot may use the present techniques to answer the query based on the statement(s). In some embodiments, an input in some other modality besides natural language may be converted into natural language, and the present techniques may be used to logically reason or answer questions about the input. For example, time-series data (e.g., a video comprising a time-series of frames, a time-series of sensor data, a time-series of financial or stock performance, etc.) may be converted into a sequence of natural language statements in various ways that may depend on the type of data involved. By way of nonlimiting example, any known technique may be used to generate a textual representation (e.g., a summary of the content) of each time-series data point (e.g., each frame in the video, each sensor measurement, each financial data point or stock price) to create a sequence of natural language statements, and the present techniques may be used to reason about and/or answer questions about the sequence of statements. As such, time-series data may be converted to natural language statements, questions may be asked about the time-series data, and the present techniques may use logical reasoning to answer the questions. Using a video (e.g., a surveillance video or a video of a surgery) as an example, the present techniques may be used to answer questions about the content of the video or generate a logical explanation of the video. Using tabular data (e.g., financial or stock performance represented in tabular format) as an example, the tabular data may be converted to logical statements, and the present techniques may be used to answer questions about, or generate a logical explanation of, the data (e.g., explain outliers, consequences of increased debt or reduced assets, etc.). These are just a few examples, and other applications may be implemented within the scope of the present disclosure.

As such, generative AI systems may use logical reasoning capabilities to evaluate natural language, software, and/or other types of inputs, and logical assessments may be formulated and returned in natural language. As a result, unlike conventional techniques, the present techniques not only provide a way for LLMs, VLMs, and other generative AI systems to logically reason about statements like natural language input statements or lines of code, they also provide explainability (e.g., reasoning, rationale, etc.) for the logical assessments. Accordingly, the present techniques may be used to provide transparency in decision making in contexts such as those in the legal, medical and health care, financial services, and code generation fields, in fields governed by regulations, and/or in any field in which the stakes are high or decisions require precision and explainability.

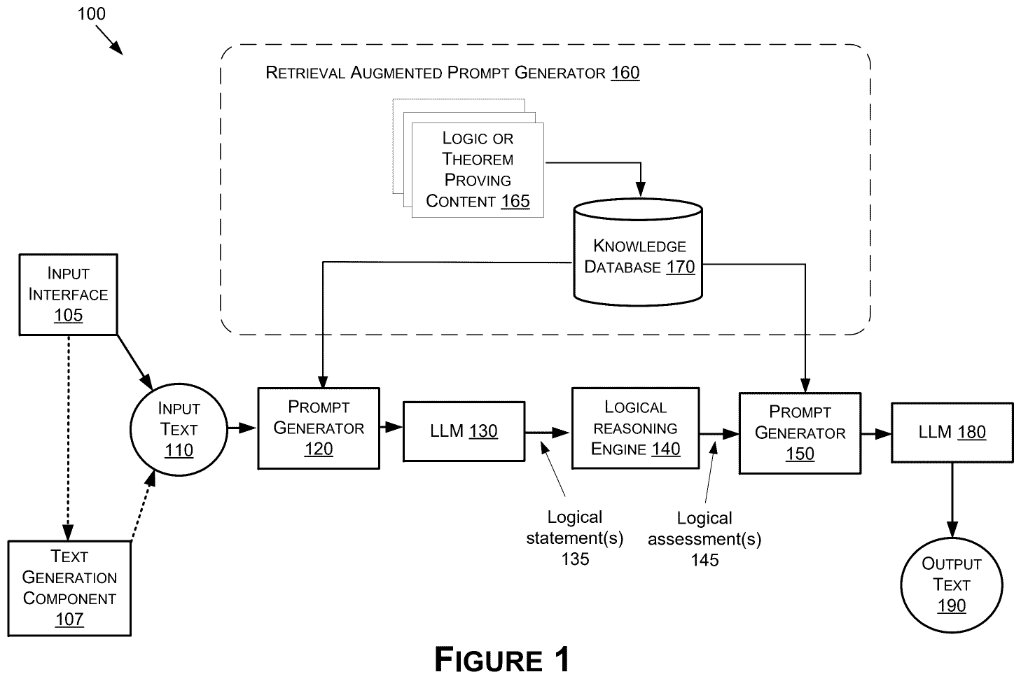

With reference to FIG. 1, FIG. 1 is an example logical reasoning system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

In an example data flow through the logical reasoning system 100 of FIG. 1, the logical reasoning system 100 receives input text 110 (e.g., via an input interface 105 such as an interface of a chatbot), and a prompt generator 120 may use the input text 110 to prompt an LLM 130 to convert the input text 110 from a first (e.g., natural, programming) language into logical statement(s) 135 in a format specified by a designated logic specification language compatible with (e.g., digestible by, understood by, usable by, etc.) a logical reasoning engine 140. The logical statement(s) 135 may be processed by the logical reasoning engine 140 to generate one or more logical assessments 145, and a prompt generator 150 may use the logical assessment(s) 145 to prompt an LLM 180 to generate a natural language response explaining the logical assessment(s) 145, answering a question about the logical assessment(s) 145, or providing some other information associated with the logical assessment(s) 145. In some embodiments, a retrieval augmented prompt generator 160 may augment the prompt provided to the LLM 130 and/or the LLM 180 with information encoded in a knowledge database 170 about logic, theorem proving, and/or the logic specification language used by the logical reasoning engine 140.

The input text 110 may represent one or more (e.g., natural language, software) statements and/or queries (or questions), which may be received in various ways. In some embodiments, the input text 110 is entered into an input interface 105 (e.g., a graphical user interface (GUI) like a form or a chat interface). For example, a chatbot provided by a website or mobile app may accept one or more user queries and provide them as the input text 110 to the prompt generator 120. In some embodiments, spoken input received through an audio interface of the input interface 105 is provided to a text generation component 107, which may convert the spoken input into text using voice recognition and/or natural language processing, and the resulting text may be used as the input text 110. In some embodiments, visual input (e.g., sign language such as American Sign Language) received through a visual interface of the input interface 105 is provided to the text generation component 107, which may convert the visual input into text using visual recognition and/or natural language processing, and the resulting text may be used as the input text 110. The input text 110 may be received through one or more application programming interfaces (APIs) that connect some upstream application or functionality, may be recognized by the text generation component 107 from one or more document scans or images using optical character recognition (OCR), may be generated by the text generation component 107 using any known detection or summarization technique (e.g., summarizing the visual content of one or more images or video frames, summarizing some other data such as textual, numerical, or audio data), and/or otherwise. For example, image captioning techniques (e.g., Contrastive Language-Image Pre-training (CLIP)) may rely on one or more neural networks to analyze images and generate descriptive text that explains the contents of the images in natural language. In some embodiments, data summarization techniques may convert time-series or other types of data into understandable summaries, for example, using any known data analysis, feature extraction, and/or natural language generation techniques. These are meant simply as examples, and other sources for the input text 110 are contemplated within the scope of the present disclosure.

As such, the prompt generator 120 may use the input text 110 to prompt the LLM 130. For example, the prompt generator 120 may use one or more template prompts with one or more slots for input statements and/or queries. The template prompt(s) may include a system prompt that sets up, guides, or defines the context for an interaction with the LLM 130 (e.g., “You are a helpful logician and an expert in mathematical logic and theorem proving. You will help convert statements in English to first-order logical formulas in TPTP format.”), may include a user or task-focused prompt instructing the LLM 130 to perform a task or asking a question to be answered by the LLM 130 (e.g., “Convert the following English statements to a first-order formula in TPTP format: [the input text 110]”), and/or may include an assistant prompt rephrasing, expanding, or clarifying the prompt or task. The prompt generator 120 may construct any number of prompts and apply them to the LLM 130. For example, prompt generator 120 may construct one or more prompts that populate a single slot with the input text 110. In some embodiments, the prompt generator 120 may use any known technique to parse and identify statements from questions in the input text 110 and may construct a prompt for each statement, sets of statements, or all statements, and a prompt for each question (or all questions). These are just a few examples, and other ways of generating prompt(s) using the input text 110 are contemplated within the scope of the present disclosure.

At a high level, the LLM 130 may accept a prompt comprising the input text 110 (e.g., generated by the prompt generator 120) and may use the prompt to generate logical statement(s) 135 that represent the input text 110 in a logic specification language that is compatible with (e.g., digestible by, understood by, usable by, etc.) the logical reasoning engine 140.

A logical reasoning engine is a computational system designed to apply the principles of logical reasoning, typically by manipulating symbols and following rules of logic to infer new information or make decisions based on given premises. Logical reasoning engines often rely on mathematical logic and formalisms like propositional logic, predicate logic, or other logic systems to model and solve problems. There are a variety of logical reasoning engines such as theorem provers and SMT solvers that are designed to accept inputs formatted in specialized logic specification languages (also known as logic programming languages) tailored for logical reasoning tasks. Logic specification languages are typically characterized by a set of syntax and semantic rules that define how expressions may be constructed and what they mean. Some example logic specification languages that may be used by the logical reasoning engine 140 include: Thousands of Problems for Theorem Provers (TPTP), Prolog, Web Ontology Language (OWL), Satisfiability Modulo Theories Library (SMT-LIB), and Common Algebraic Specification Language (CASL). Taking TPTP as an example, TPTP provides a framework for automated theorem proving and specifies syntax for defining problems, axioms, and conjectures in a standard, machine-readable format. Logic specification languages such as this may serve to standardize the input for any number of logical reasoning engines, facilitating interoperability and benchmarking across different systems. Logical reasoning engines that accept TPTP may therefore process a broad range of problems.

Continuing with TPTP as an example, a TPTP file may comprise a series of annotated logical statements or formulas (e.g., axioms, hypotheses, conjectures, derived logical statements or formulas), each of which may be represented as a first order form (FOF), typed higher-order form (THF), or others using a designated syntax. In TPTP, the syntax may be represented as:
language(name, role, formula, source), [useful_info].
   where “language” represents the type of form (e.g., fof for first-order formulas), “name” represents a unique identifier for the formula, “role” represents the role of the formula (e.g., as axiom, hypothesis), “formula” represents the actual logical statement or formula, “source” represents optional information about the source of the formula, and “useful_info” represents optional annotations.

Further, logic specification language like TPTP may specify standardized logical symbols, quantifiers, and/or other syntax which may be used to represent a logical formula, logical relations, logical operations, or other logical statements. For example, TPTP uses “!” for universal quantification (for all) and “?” for existential quantification (exists). More specifically, the universal quantifier may be used as in “![X]:” to assert that a formula holds for all values of X, and the existential quantifier may be used as in “?[X]:” to assert that there exists at least one value of X for which the formula holds. Predicates representing properties or relations among entities may be denoted by names that start with uppercase letters (e.g., P(X, Y)), and functions that return values based on their inputs may be denoted by names that start with lowercase letters (e.g., f(X, Y)). Different symbols may be used to denote different logical connectives, such as a conjunction (e.g., &), disjunction (e.g., |), negation (e.g., ˜), implication (e.g., =>), or equivalence (e.g., <=>). For example, a first-order formula in TPT may look like:

$$fof ( example\_formula , axiom , ! [ X ] : ( ? [ Y ] : ( P ( X ) \& Q ( Y ) \text{=>} R ( X , Y ) ) ) ) .$$

which states, “For all X, there exists a Y such that if P(X) and Q(Y) are true, then R(X, Y) is also true.” The foregoing description is meant simply as an example to illustrate some possible ways in which a logic specification language may define a format for specifying logical statements, and other logic specification languages and/or syntaxes may be implemented within the scope of the present disclosure.

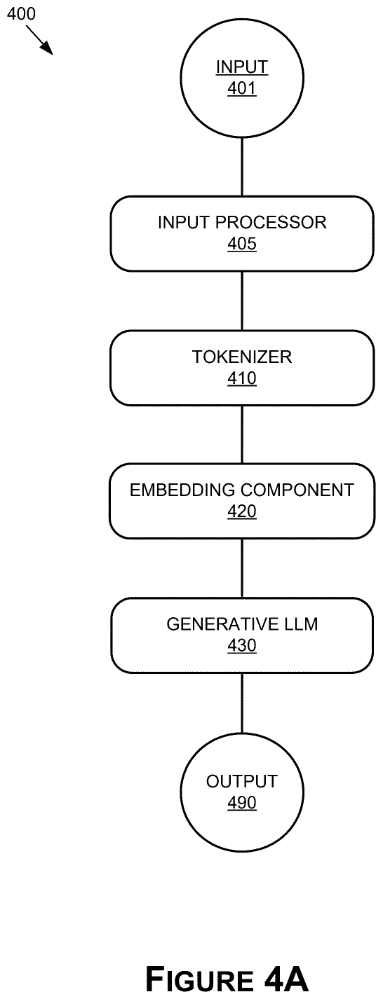

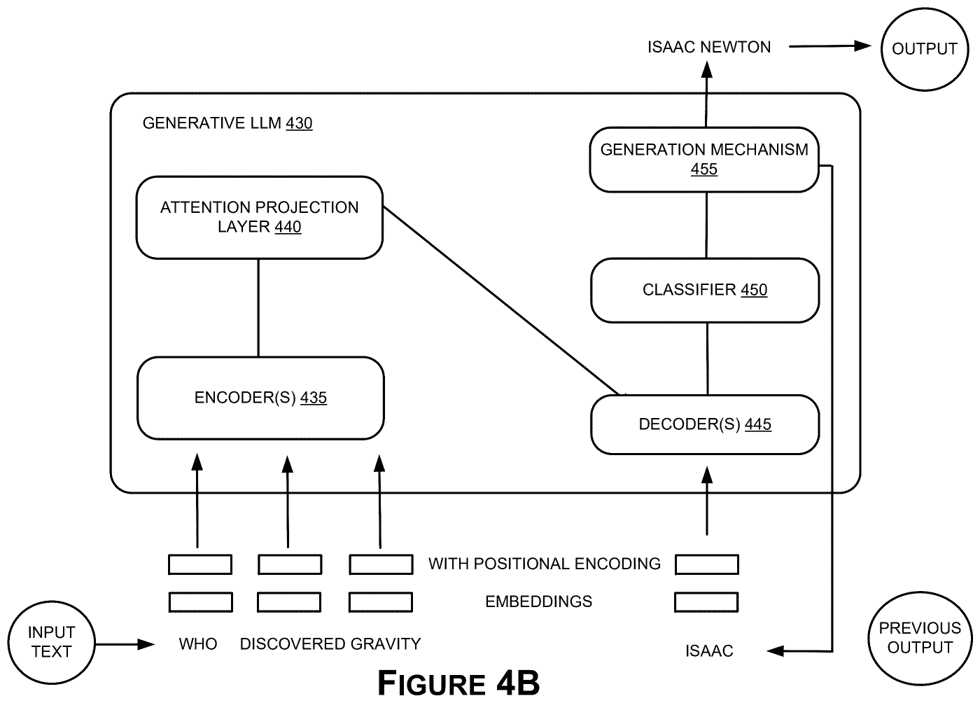

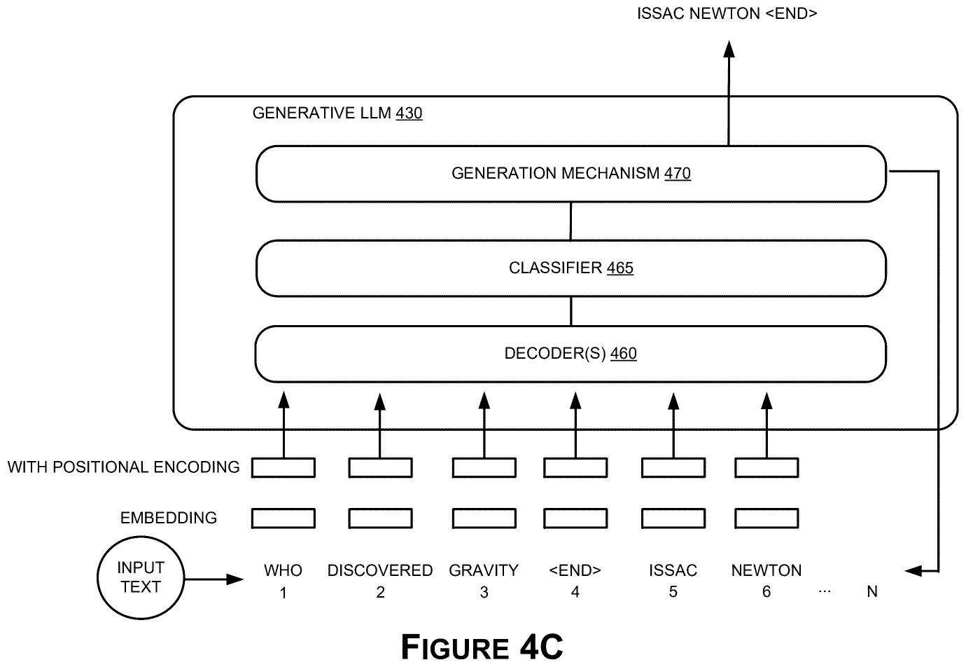

Having described an example format for a logical specification language, and returning to the LLM 130, the LLM 130 may be used to convert the input text 110 (e.g., provided in a prompt by the prompt generator 120) from a first (e.g., natural, programming) language to a logic specification language such as TPTP. Generally, the LLM 130 may be any suitable LLM, such as the example generative LLM system 400 of FIG. 4A or the generative LLM 430 of FIG. 4A, 4B, or 4C. Depending on the implementation, the LLM 130 may include a pre-trained or foundational LLM, such as NVIDIA's Megatron-Turing Natural Language Generation (MT-NLG) or Megatron-LM; OpenAI's GPT series; Google's T5 or Pathways Language Model (PaLM); Meta's BlenderBot or Large Language Model Meta AI (LLaMA) series, Anthropic's Claude series, or others.

In some embodiments, to improve the conversion or translation, the LLM 130 may be tuned (e.g., using fine-tuning, prompt tuning, p-tuning, few-shot learning, transfer learning, retrieval augmented generation) or otherwise adapted to convert from the first (e.g., natural, programming) language into the format specified by the logic specification language. By way of nonlimiting example, a (e.g., pre-trained or foundational) LLM may be fine-tuned using a dataset that associates one or more sets of statement(s) in the first language (e.g., incorporated into one or more template prompts) with corresponding one or more sets of (e.g., first-order and/or higher-order) logical statement(s) in the target logic specification language supported by the logical reasoning engine 140. As such, and taking a first training data point as an example, a set of training statements in the first language may be inserted into one or more template prompts that instruct the LLM to convert the statement(s) into corresponding (e.g., first-order and/or higher-order) logical statement(s) in a designated logic specification language, the resulting prompt(s) may be applied to the LLM, and the generated output may be compared to ground truth logical statement(s) in the target logic specification language and used to update the LLM. The process may be repeated over any number of training data points to fine-tune the LLM 130 to translate into the logic specification language.

Taking translation from natural language into TPTP as an example, an input statement such as “Every boy who loves Alexis hates every other boy who Alexis loves” may be inserted into a template prompt such as “You are a helpful logician and an expert in mathematical logic and theorem proving. You will help convert statements in English to first-order logical formulas in TPTP format. Convert the following English statement to a first-order formula in TPTP format: [input statement].” As such, the resulting prompt may be applied to the LLM 130 to generate the corresponding TPTP format:

$$fof ( ex6\_ 179 , axiom , ! [ X ] : boy ( X ) \& loves ( X , alexis ) ) \text{} \text{=>} ! [ \text{} Y ] \text{} : ( boy ( Y ) \& loves ( alexis , Y ) \& ( Y != X ) \text{=>} hates ( X , Y ) ) ) .$$

In another example, the LLM 130 may be prompted to convert the following English statements into the corresponding TPTP format:
Example input statements: A city has two types of people, knights and knaves. Every person in a certain city is either a knight or a knave. Knights always tell the truth. Knaves always lie. Mel and zoey are two persons in the city. zoey says that mel is a knave. mel says neither zoey or mel are knaves. Is mel a knave?
Example TPTP output:

tff(person_type, type, person: $tType).
tff(knight_type, type, knight: person > $o).
tff(knave_type, type, knave: person > $o).
tff(knight_or_knave, axiom, ![P: person]: (knight(P) <~> knave(P))).
tff(says_type, type, says: (person * $o) > $o).
tff(knights_tell_truth, axiom, ![P: person, S: $o]: ((knight(P) & says(P,
S)) => S)).
tff(knaves_lie, axiom, ![P: person, S: $o]: ((knave(P) & says(P,
S)) => ~S)).
tff(zoey_type, type, zoey: person).
tff(mel_type, type, mel: person).
tff(zoey_says, hypothesis, says(zoey, knave(mel))).
tff(mel_says, hypothesis, says(mel, (~knave(mel) & ~knave(zoey)))).
tff(mel_is_knave, conjecture, knave(mel)).

In this example, the LLM 130 recognized the question at the end of the input statements and converted it into a corresponding conjecture in TPTP. Note that by including the TPTP type declarations in the ground truth training formulas, the LLM 130 will learn to include the type declarations defining the type of each variable at the beginning of the logical statement(s) 135. Additionally or alternatively, depending on the implementation, the output of the LLM 130 may be processed to extract the logical statement(s) 135, and/or identify and add any necessary type declarations.

The foregoing example involved a logic puzzle, but other types of input statements may be applied, such as those originating in an article, speech, book, dialogue, lecture, letter, email, research paper, software code, instruction manual, a set of requirements, and/or others. For example, if company A is being acquired by company B, the governing legal requirements may be supplied with a question to apply the legal requirements to a corresponding set of facts (e.g., “Company A is being acquired by company B. Can company A's open-source software be closed source after the acquisition?”). In this example, the LLM 130 may be used to convert the supplied legal requirements and the declarative statement about the acquisition into corresponding axioms, and convert the question into a corresponding conjecture.

These examples are meant simply to illustrate some possible implementations and applications, and other variations (e.g., in input languages, logic specification languages, type of logical formulas and/or variables used to encode the input statements, etc.) are contemplated within the scope of the present disclosure. For example, many English statements may be encoded as first order formulas (e.g., using Boolean statements specifying variables as true or false). More complex statements like those appearing in software code may be encoded using higher order statements and/or other types of variables (e.g., integer, decimal). In a simple example, a month may be encoded using twelve Boolean variables or one integer variable that can take value from 1-12. In certain domains like software (e.g., for control systems that involve differential equations), certain statements may be encoded using higher-order logic. Generally, the LLM 130 may learn to apply a desired encoding behavior by including corresponding examples in its training dataset.

As such, the LLM 130 may be used to convert or translate the input text 110 into logical statement(s) 135 in the logic specification language that is compatible with (e.g., digestible by, understood by, used by, etc.) the logical reasoning engine 140. Accordingly, the logical statement(s) 135 may be applied to the logical reasoning engine 140 to derive one or more logical assessments 145 of the logical statement(s) 135 (e.g., deduced facts, a proof or refutation of a conjecture, results of a consistency check, etc.)

The logical reasoning engine 140 may be any known logical reasoning engine, and may use any known technique to generate the logical assessment(s) 145 based on the logical statement(s) 135. For example, the logical reasoning engine 140 may parse the logical statement(s) 135, check the syntax and semantics of each statement (e.g., confirming the statement conforms to the rules of the supported logic specification language, verifying predicates and functions are used with the correct number of arguments), encode the logical statement(s) 135 using data structures like trees or graphs, and/or apply logical inference rules to derive new information or make decisions based on the logical statement(s) 135. The logical reasoning engine 140 may perform various types of logical assessments, such as consistency checking (e.g., verifying whether the logical statement(s) 135 are internally consistent and without contradiction), validity testing (e.g., assessing whether certain conclusions necessarily follow from given premises), satisfiability (e.g., checking if there is at least one interpretation that makes a formula true), entailment (e.g., determining whether a particular fact logically follows from the logical statement(s) 135), model or property checking (e.g., verifying properties of a model such as a software model represented by the logical statement(s) 135), and/or others. Some examples of logical reasoning engines include Prolog, Answer Set Programming (ASP) tools like Clingo and DataLog with Disjunction (DLV), automated theorem provers such as Z3 and Vampire, SMS or other satisfiability (SAT) solvers like MiniSAT, and others.

Generally, the logical reasoning engine 140 may output its logical assessment(s) 145 in various forms (e.g., a binary or Boolean value representing the outcome of a check like satisfiability or validity, a proof or derivation showing how a conclusion is reached from the logical statement(s) 135 using logical rules, one or more counterexamples demonstrating where a model represented by the logical statement(s) 135 does not hold, etc.). The logical assessment(s) 145 may take the form of a set of logical statement(s) in a logic specification language, which may be the same as the logic specification language accepted as input.

In some embodiments, the LLM 180 may be used to convert the logical assessment(s) 145 of the logical reasoning engine 140 into natural language. For example, the prompt generator 150 may insert one or more of the logical assessment(s) 145 into one or more template prompts that instruct the LLM 180 to explain the logical assessment(s) 145 in natural language. The template prompt(s) may include a system prompt that sets up, guides, or defines the context for an interaction with the LLM 180 (e.g., “You are a helpful logician and an expert in mathematical logic and theorem proving. You will use plain English to help explain proofs given in first-order logical formulas in TPTP format.”), may include a user or task-focused prompt instructing the LLM 180 to perform a task or asking a question to be answered by the LLM 180 (e.g., “Explain the following set of proof derivations given in TPTP format using plain English: [the logical assessment(s) 145]”), and/or may include an assistant prompt rephrasing, expanding, or clarifying the prompt or task. The prompt generator 150 may construct any number of prompts and apply them to the LLM 180. For example, prompt generator 150 may construct one or more prompts that populate a single slot with the logical assessment(s) 145. In some embodiments, the prompt generator 120 and/or 150 may extract a question from the input text 110 or the logical statement(s) 135, and the prompt generator 150 may insert the question into a corresponding slot in one or more template prompts (e.g., “Answer the following question in plain English based on the following set of proof derivations given in TPTP format. Proof derivations: [logical assessment(s) 145]. Question: [question]”). These are just a few examples, and other ways of generating a prompt using the logical assessment(s) 145 may be implemented within the scope of the present disclosure.

As such, the prompt generator 150 may generate and apply one or more prompts to the LLM 180, which the LLM 180 may use to generate a response (e.g., an answer to a question about and/or a natural language explanation of the logical assessment(s) 145). Generally, the LLM 180 may be any suitable LLM, such as the example generative LLM system 400 of FIG. 4A or the generative LLM 430 of FIG. 4A, 4B, or 4C. Depending on the implementation, the LLM 180 may include a pre-trained or foundational LLM, such as NVIDIA's Megatron-Turing Natural Language Generation (MT-NLG) or Megatron-LM; OpenAI's GPT series; Google's T5 or Pathways Language Model (PaLM); Meta's BlenderBot or Large Language Model Meta AI (LLaMA) series, Anthropic's Claude series, or others. In some embodiments, to improve the natural language response, the LLM 180 may be tuned (e.g., using fine-tuning, prompt tuning, p-tuning, few-shot learning, transfer learning, retrieval augmented generation) or otherwise adapted to generate natural language explanations or answer questions about the logical assessment(s) 145 (e.g., using a dataset that associates logical assessments such as proofs with corresponding summaries, explanations of new facts, etc.).

In some embodiments, the prompt generator 150 may provide a generated prompt to the retrieval augmented prompt generator 160, the retrieval augmented prompt generator 160 may use retrieval augmented generation to augment the prompt using logic or theorem proving content 165 stored in the knowledge database 170, and the prompt generator 150 (or the retrieval augmented prompt generator 160) may provide the augmented prompt to the LLM 180. Additionally or alternatively, the prompt generator 120 may provide a generated prompt to the retrieval augmented prompt generator 160, the retrieval augmented prompt generator 160 may use retrieval augmented generation to augment the prompt using the logic or theorem proving content 165, and the prompt generator 120 (or the retrieval augmented prompt generator 160) may provide the augmented prompt to the LLM 130.

More specifically, any suitable logic or theorem proving content 165 may be encoded and stored in the knowledge database 170 using any known technique. For example, the logic or theorem proving content 165 may comprise textual content (e.g., one or more text files (e.g., .txt), document files (e.g., .docx, .pdf), or web files (e.g., .html)) representing one or more explanations, tutorials, or other educational materials that provide information about the logic specification language or theorem proving techniques used by the logic reasoning engine 140. Continuing with the example implementation involving the TPTP format, the logic or theorem proving content 165 may take the form of one or more research papers and/or other documentation explaining the TPTP format. Generally, any known technique may be used to encode the logic or theorem proving content 165. For example, the retrieval augmented prompt generator 160 may use OCR to recognize text from each applicable file representing the logic or theorem proving content 165 (e.g., removing tables and/or equations using regular expressions, custom scripts, or other document parsing tools), and may use OpenAI's text embeddings API to convert the text content from each unit (e.g., each file) into a corresponding embedding. In some embodiments, the retrieval augmented prompt generator 160 may combine multiple embeddings into a single, unified embedding that encapsulates the collective semantic information of all the logic or theorem proving content 165 (e.g., by some type of averaging such as weighted averaging, using dimension reduction, etc.). As such, the embedding(s) representing the logic or theorem proving content 165 may be stored in the knowledge database 170, which may take the form of a vector database such as VectorDB or Chroma.

Accordingly, the retrieval augmented prompt generator 160 may use any known retrieval augmented generation technique to augment a received prompt based on the embedding(s) representing the logic or theorem proving content 165 in the knowledge database 170. Taking a single unified database embedding as an example, when the retrieval augmented prompt generator 160 receives a prompt, it may convert the prompt into an embedding using the same model that was used for the database embedding and may compute a measure of similarity (e.g., cosine, Euclidean) between the prompt's embedding and the database's single embedding (e.g., using Mean Reciprocal Rank (MRR) or Mean Average Precision (mAP)). If the measure of similarity meets some threshold similarity, the retrieval augmented prompt generator 160 may augment the prompt based on the logic or theorem proving content 165 in the knowledge database 170 (e.g., by appending a general summary, segment(s) of text determined to best represent the overall content, targeted content determined to align with the prompt, and/or other explanatory content extracted or otherwise derived from the logic or theorem proving content 165). In some embodiments, if the measure of similarity does not satisfy the threshold, the retrieval augmented prompt generator 160 may determine not to augment the prompt. In some embodiments, the knowledge database 170 may store multiple embeddings, the retrieval augmented prompt generator 160 may query the knowledge database 170 to retrieve the most relevant documents or text snippets, and the retrieval augmented prompt generator 160 may append the retrieved content to a prompt. These are meant simply as examples, and other types of retrieval augmented generation may be implemented within the scope of the present disclosure.

As such, and returning to the LLM 180, the prompt generator 150 (and/or the retrieval augmented prompt generator 160) may prompt the LLM 180 to explain or answer a question about the logical assessment(s) 145, and the LLM 180 or some other component of the logical reasoning system 100 may provide the generated text as output text 190 (e.g., via a chatbot interface). In some embodiments, the output text 190 may be further processed for visual and/or audible presentation (e.g., via the chatbot interface).

By way of illustration, consider an example in which the input text 110 includes the known logic puzzle Who Killed Aunt Agatha? which includes a series of statements about possible suspects in the death of Aunt Agatha, and concludes with the question, “Who Killed Aunt Agatha?” The prompt generator 120 may prompt the LLM 130 to convert the statements into corresponding logical statements (e.g., axioms and a conjecture), which the logical reasoning engine (e.g., Vampire) may evaluate and use to generate a logical assessment proving or refuting the conjecture, given the axioms. By prompting the LLM 180 to explain the logical assessment, the LLM 180 may generate a natural language explanation such as:
The given set of proof derivations is a proof in first-order logic that aims to refute the negated conjecture “killed(agatha, agatha)”. The proof uses various input formulas and applies logical inference rules to derive contradictions, ultimately showing that the negated conjecture is false.
Here is a step-by-step explanation of the proof:
The input formulas state various relationships and properties involving the predicates “killed”, “lives”, “hates”, “richer”, and the constants “agatha”, “charles”, “butler”. These formulas provide the initial information for the proof.
The negated conjecture “killed(agatha, agatha)” is introduced as the goal to be refuted.
The proof proceeds by applying logical inference rules such as resolution, superposition, backward demodulation, and subsumption resolution to derive new formulas.
The derived formulas are represented in conjunctive normal form (CNF), which is a standard form for logical formulas.
The proof continues by applying various transformations and simplifications to the formulas, such as existential instantiation, flattening, and ennf transformation.
The proof also uses choice axioms and skolemization to introduce new variables and simplify the formulas.
At each step, the proof aims to derive contradictions or inconsistencies in the form of clauses that contain complementary literals (e.g., “p” and “˜p”).
The proof reaches a contradiction when it derives the clause “$false”, which represents a logical contradiction.
The proof terminates with the result “Refutation”, indicating that the negated conjecture has been successfully refuted.
In summary, the given set of proof derivations demonstrates that the negated conjecture “killed(agatha, agatha)” is false, providing evidence that Agatha did indeed kill herself.

In another example, the input text 110 may comprise or identify one or more generated statements (e.g., generated software code) generated by a first LLM (e.g., the LLM 130, the LLM 180, some other LLM) in response to a current or previous prompt, and may include an instruction to explain why the first LLM generated the statements. As such, the prompt generator 120 may prompt the LLM 130 to convert the generated statements into corresponding logical statements, which the logical reasoning engine 140 may evaluate and use to generate a logical assessment. In some embodiments, the first LLM may use the logical assessment (and/or a natural language explanation thereof) to verify, explain, and/or regenerate some or all of the generated statements for logical consistency. By way of nonlimiting example, any known generative technique may be used to generate software code, and the logical reasoning system 100 may be prompted to explain or verify the generated code. Additionally or alternatively, an LLM may invoke any known generative technique to generate software code, use the logical reasoning system 100 to verify the software code as it is being generated, and/or rewrite the software code to satisfy logical formulas representing the logic of the generated software code and generated using use the logical reasoning system 100. These are just a few examples, and other variations are contemplated within the scope of the present disclosure.

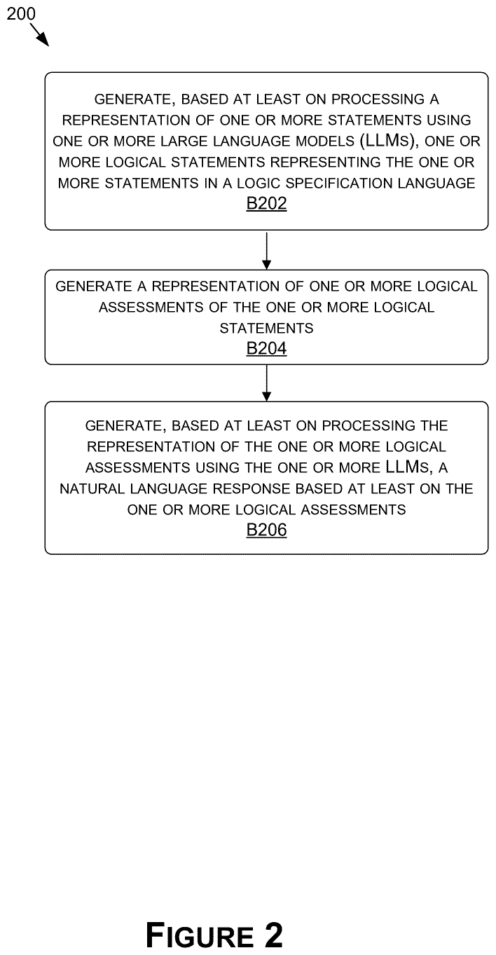

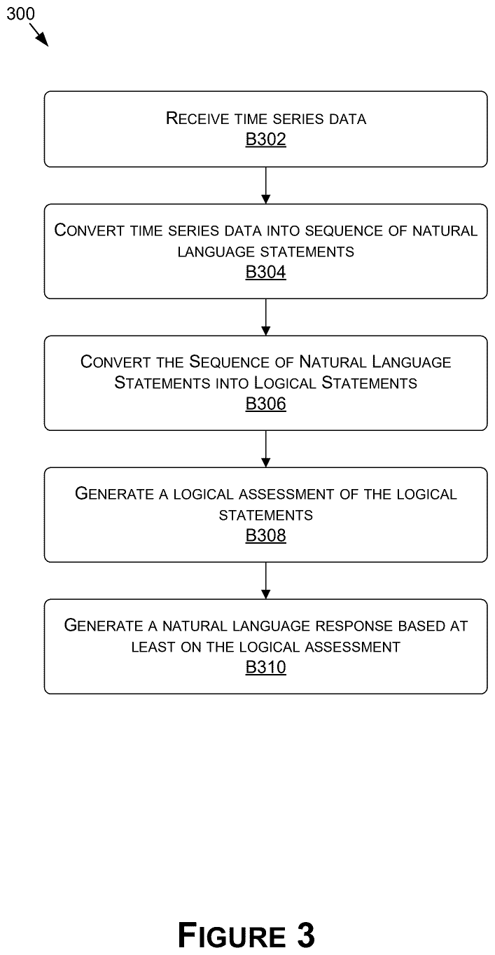

Now referring to FIGS. 2 and 3, each block of methods 200 and 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 200 and 300 are described, by way of example, with respect to the logical reasoning system 100 of FIG. 1. However, this method may additionally or alternatively be executed by any one system, or any combination of systems, including, but not limited to, those described herein.

FIG. 2 is a flow diagram showing a method 200 for generating a natural language response based on one or more logical assessments of one or more statements, in accordance with some embodiments of the present disclosure. The method 200, at block B202, includes generating, based at least on processing a representation of one or more (e.g., natural language, software) statements using one or more large language models (LLMs), one or more logical statements representing the one or more statements in a logic specification language. For example, with respect to FIG. 1, the prompt generator 120 may use the input text 110 to prompt the LLM 130 to convert the input text 110 from a first (e.g., natural, programming) language into logical statement(s) 135 in a format specified by a designated logic specification language.

The method 200, at block B204, includes generating a representation of one or more logical assessments of the one or more logical statements. For example, with respect to FIG. 1, the logical statement(s) 135 may be applied to the logical reasoning engine 140 to derive one or more logical assessments 145 of the logical statement(s) 135 (e.g., deduced facts, a proof or refutation of a conjecture, results of a consistency check, etc.).

The method 200, at block B206, includes generating, based at least on processing the representation of the one or more logical assessments using the one or more LLMs, a natural language response based at least on the one or more logical assessments. For example, with respect to FIG. 1, the prompt generator 150 may use the logical assessment(s) 145 generated by the logical reasoning engine 140 to prompt the LLM 180 to generate a natural language response explaining the logical assessment(s) 145, answering a question about the logical assessment(s) 145, or providing some other information associated with the logical assessment(s) 145.

FIG. 3 is a data flow diagram illustrating a method 300 for generating a natural language response based on one or more logical assessments of time-series data, in accordance with some embodiments of the present disclosure. The method 300, at block B302, includes receiving time-series data. For example, with respect to FIG. 1, the input interface 105 may comprise a GUI and/or an API used to receive or otherwise access designated (e.g., uploaded or otherwise identified) time-series data, such as univariate time-series data involving a single variable measured over time (e.g., daily temperature readings), multivariate time-series data involving multiple variables recorded over time (e.g., stock prices together with trading volumes), continuous time-series data (e.g., continuous monitoring of heart rates using medical devices), discrete time-series data recorded at set intervals (e.g., hourly electricity consumption measurements or a video consisting of a sequence of images separated by a fixed time interval), and/or event-based time-series data capturing information only when certain events occur (e.g., transaction logs in a database whenever purchases are made). Various implementations may involve different types of time-series data.

The method 300, at block B304, includes converting the time-series data into a sequence of natural language statements. For example, with respect to FIG. 1, the text generation component 107 may convert the time-series data into natural language using any known detection or summarization technique (e.g., summarizing the visual content of one or more images or video frames, summarizing some other data such as textual, numerical, or audio data) in a manner that depends on the type of data and/or the implementation. For univariate time-series data, the text generation component 107 may use any known technique to identify trends or changes and describe them in natural language (e.g., “The temperature steadily increased over the first week of March.”). For multivariate time-series data, the text generation component 107 may use any known technique to identify and describe the relationship between multiple variables (e.g., “Trading volume increased in the first quarter of 2023, and the stock price of company A also rose significantly.” For continuous time-series data, the text generation component 107 may use any known technique to identify and summarize periods of change or stability (e.g., “The patient's heart rate showed an irregular pattern with frequent spikes during the afternoon.”). For discrete time-series data, the text generation component 107 may any known technique to identify and summarize changes (e.g., “Electricity consumption peaked during the early evening hours.”). For event-based time-series data, the text generation component 107 may use any known technique to identify and summarize events and/or trends (e.g., “A large number of transactions were recorded just after promotional emails were sent.”).

The method 300, at block B306, includes converting the sequence of natural language statements into logical statements. For example, with respect to FIG. 1, the prompt generator 120 may use the input text 110 to prompt the LLM 130 to convert the input text 110 from a first (e.g., natural, programming) language into logical statement(s) 135 in a format specified by a designated logic specification language.

The method 300, at block B308, includes generating a logical assessment of the logical statements. For example, with respect to FIG. 1, the logical statement(s) 135 may be applied to the logical reasoning engine 140 to derive one or more logical assessments 145 of the logical statement(s) 135 (e.g., deduced facts, a proof or refutation of a conjecture, results of a consistency check, etc.).

The method 300, at block B310, includes generating a natural language response based at least on the logical assessment. For example, with respect to FIG. 1, the prompt generator 150 may use the logical assessment(s) 145 generated by the logical reasoning engine 140 to prompt the LLM 180 to generate a natural language response explaining the logical assessment(s) 145, answering a question about the logical assessment(s) 145, or providing some other information associated with the logical assessment(s) 145. In some embodiments, the natural language response may be further processed for visual and/or audible presentation.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs) or one or more vision language models (VLMs), systems for performing light transport simulation, systems for performing collaborative content creation for 3D assets, systems implemented at least partially using cloud computing resources, and/or other types of systems.

### Example Large Language Models

Large language models (LLMs) are a type of generative artificial intelligence (AI) that can understand, summarize, translate, or otherwise generate human-like text based on the context provided in input prompts or queries. These language models are often considered “large” based on their training on massive datasets and having architectures with large number of learnable network parameters (weights and biases), with popular LLMs having millions or billions of parameters. LLMs have become proficient in summarizing textual data, analyzing and extracting insights from data, and generating new text in user-specified styles, tones, or formats. Some LLMs like the early versions of chatbots (e.g., ChatGPT) focus exclusively on text processing, whereas some multimodal LLMs can accept, understand, and/or generate text along with other types of content like images, audio, and/or video. For example, visual language models (VLMs) are a type of LLM that can accept visual and textual input and/or generate visual and textual output.

There are different types of LLM architectures that use different techniques for understanding and generating human-like text. Some early LLM architectures used recurrent neural networks (RNNs) or long short-term memory networks (LSTMs), whereas many modern LLMs use a transformer architecture that relies on self-attention mechanisms to understand and recognize relationships between words or tokens. An LLM may include encoder and/or decoder block(s). Discriminative or encoder-only LLMs like BERT (Bidirectional Encoder Representations from Transformers) are well-suited for tasks that involve language comprehension such as classification, sentiment analysis, question answering, and named entity recognition. Generative or decoder-only LLMs like GPT (Generative Pretrained Transformer) are well-suited for tasks that involve language and content generation such as text completion, story generation, and dialogue generation. LLMs that include both encoder and decoder components like T5 (Text-to-Text Transformer) can understand and generate content, making these models well-suited for tasks such as translation and summarization.

LLMs are primarily trained using unsupervised learning, in which an LLM learns patterns from large amounts of unlabeled text data. Due to their extensive training, LLMs often do not require task-specific or domain-specific training. These types of LLMs that have undergone extensive pre-training on vast amounts of unlabeled text data are often referred to as foundation models and are adept at a variety of tasks like question-answering, summarization, filling in missing information, and translation. Some LLMs may be tailored for a specific use case using techniques like prompt tuning, fine-tuning, and/or adding adapters.

FIG. 4A is a block diagram of an example generative LLM system 400 suitable for use in implementing some embodiments of the present disclosure. In the example illustrated in FIG. 4A, the generative LLM system 400 includes an input processor 405, a tokenizer 410, an embedding component 420, and a generative LLM 430.

At a high level, the input processor 405 may receive an input 401 comprising text and other types of input data, depending on the architecture of the generative LLM 430. Typically, the input 401 includes plain text in the form of one or more sentences, paragraphs, or documents. Additionally or alternatively, the input 401 may include numerical sequences, precomputed embeddings (e.g., word or sentence embeddings), and/or structured data (e.g., in tabular formats, JSON, or XML). In some implementations in which the generative LLM 430 is capable of processing multimodal inputs, the input 401 may combine text with image data, audio data, and/or other types of input data. Taking raw input text as an example, the input processor 405 may prepare raw input text in various ways. For example, the input processor 405 may perform various types of text cleaning to remove noise (e.g., special characters, punctuation, HTML tags, stopwords) from relevant textual content. In an example involving stopwords (common words that tend to carry little semantic meaning), the input processor 405 may remove stopwords to reduce noise and focus the generative LLM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

The tokenizer 410 may segment the (e.g., processed) text into smaller units (tokens) for subsequent analysis and processing. The tokens may represent individual words, subwords, or characters, depending on the implementation. Word-based tokenization divides the text into individual words, treating each word as a separate token. Subword tokenization breaks down words into smaller meaningful units (e.g., prefixes, suffixes, stems), enabling the generative LLM 430 to understand morphological variations and handle out-of-vocabulary words more effectively. Character-based tokenization represents each character as a separate token, enabling the generative LLM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data, the input processor 405 may resize the image data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 405 may resample an audio file to a consistent sampling rate for uniform processing, and the embedding component 420 may use any known technique to extract and encode audio features. In some implementations in which the input 401 includes video data, the input processor 405 may extract frames or apply resizing to extracted frames, and the embedding component 420 may extract features such as optical flow embeddings or video embeddings and/or may encode temporal information or sequences of frames. In some implementations in which the input 401 includes multimodal data, the embedding component 420 may fuse representations of the different types of data (e.g., text, image, audio) using techniques like early fusion (concatenation), late fusion (sequential processing), attention-based fusion, etc.

The generative LLM 430 and/or other components of the generative LLM system 400 may use different types of neural network architectures depending on the implementation. Transformer-based architectures such as those used in models like GPT typically include self-attention mechanisms that weigh the importance of different words or tokens in the input sequence and feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LLM 430, and the generative LLM 430 may process the encoded representation of the input 401 to generate an output 490, which may include responsive text and/or other types of data.

FIG. 4B is a block diagram of an example implementation in which the generative LLM 430 includes a transformer encoder-decoder. For example, assume input text such as “Who discovered gravity” is tokenized (e.g., by the tokenizer410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LLM 430.

In an example implementation, the encoder(s) 435 form an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LLM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

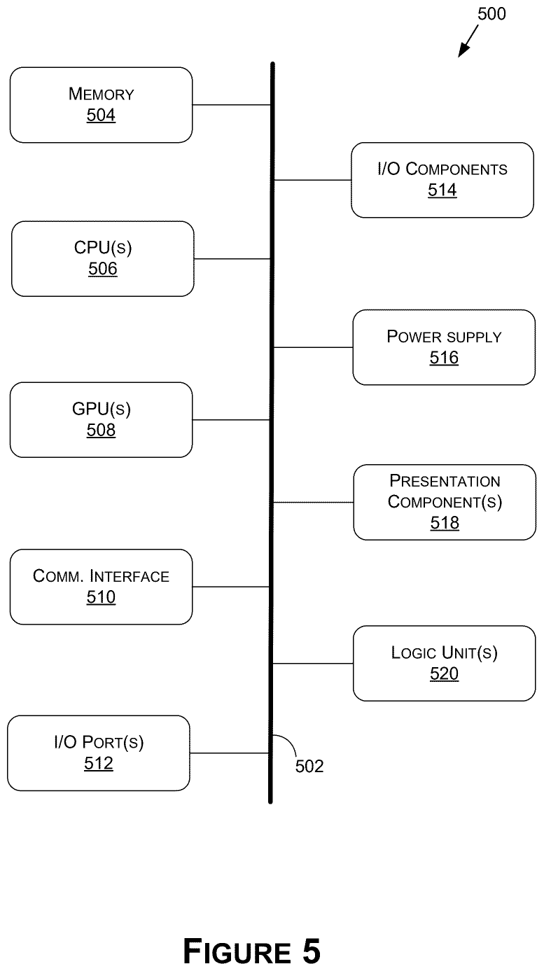

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

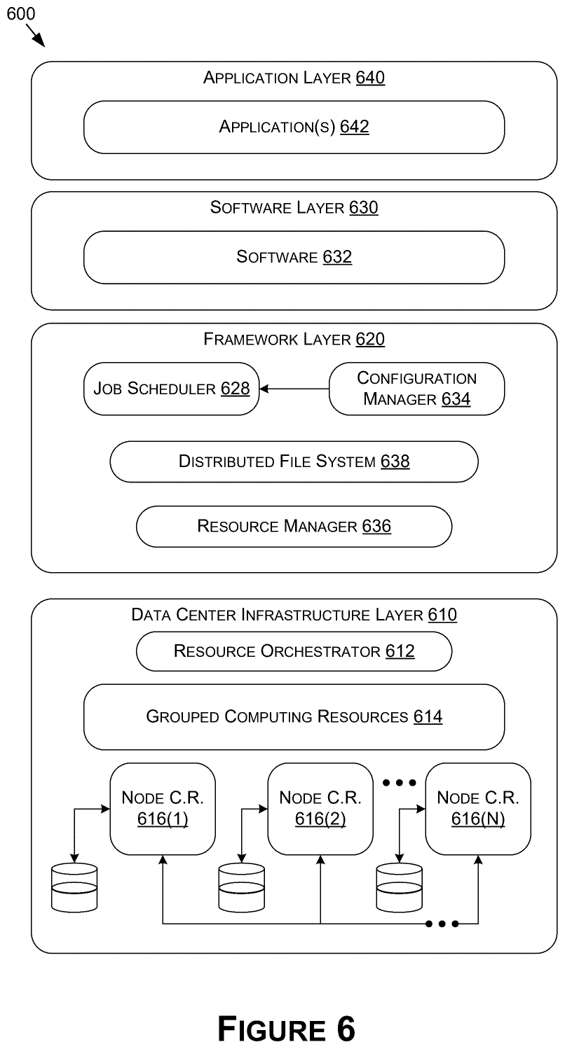

FIG. 6 illustrates an example data center 600 that may be used in at least one embodiments of the present disclosure. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:

Clause 1. One or more processors comprising processing circuitry to generate, based at least on processing a representation of one or more input statements using one or more large language models (LLMs), one or more logical statements expressed in a logic specification language and representing the one or more input statements.

Clause 2. The one or more processors of clause 1, wherein the processing circuitry is further to generate, using a logical reasoning engine corresponding to the logic specification language, a representation of one or more logical assessments of the one or more logical statements.

Clause 3. The one or more processors of clause 1 or 2, wherein the processing circuitry is further to generate, based at least on processing the representation of the one or more logical assessments using the one or more LLMs, a natural language response for the one or more input statements.

Clause 4. The one or more processors of clause 1, 2 or 3, wherein the processing circuitry is further to provide the natural language response as output, wherein the one or more input statements comprise a representation of a query, and the natural language response comprises at least one of: an explanation of, or an answer to a question about, at least a portion of the query.

Clause 5. The one or more processors of clause 1, 2, 3 or 4, wherein the processing circuitry is further to generate the representation of the one or more input statements based at least on inserting the one or more input statements into one or more template prompts that instruct the one or more LLMs to convert the one or more input statements into the logic specification language.

Clause 6. The one or more processors of clause 1, 2, 3 or 4, wherein the processing circuitry is further to generate the one or more logical statements using a first large language model of the one or more LLMs, the first large language model tuned to the logic specification language.

Clause 7. The one or more processors of clause 1, 2, 3 or 4, wherein the logical reasoning engine implements one or more solvers.

Clause 8. The one or more processors of clause 1, 2, 3 or 4, wherein the one or more logical assessments of the one or more logical statements represent at least one of: a proof or refutation of at least one of the one or more input statements, a deduced fact based on at least one of the one or more input statements, or a consistency check of at least one of the one or more input statements.

Clause 9. The one or more processors of clause 1, 2, 3 or 4, wherein the processing circuitry is further to generate the representation of the one or more logical assessments using one or more prompts generated using retrieval augmented generation and augmented with a representation of content explaining the logic specification language.

Clause 10. The one or more processors of clause 1, 2, 3 or 4, wherein the natural language response comprises an explanation of the one or more logical assessments, or an answer to a question associated with the one or more input statements based at least on the one or more logical assessments.

Clause 11. The one or more processors of clause 1, 2, 3 or 4, wherein the one or more input statements represent a sequence of image data of a video, wherein the natural language response comprises at least one of: an explanation of, or an answer to a question about, at least a portion of the video.

Clause 12. The one or more processors of clause 1, 2, 3 or 4, wherein the one or more input statements represent a sequence of time-series data, wherein the natural language response comprises at least one of: an explanation of, or an answer to a question about, at least a portion of the time-series data.

Clause 13. The one or more processors of clause 1, 2, 3 or 4, wherein the processing circuitry is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

Clause 14. A system comprising one or more processors to generate, based at least on processing a translated representation of one or more natural language statements using a logical reasoning engine, a representation of one or more logical assessments expressed in a logic specification language of the one or more natural language statements.

Clause 15. The system of clause 15, wherein the one or more processors are further to generate the translated representation of the one or more natural language statements based at least on inserting the one or more natural language statements into one or more template prompts that instruct one or more large language models to convert the one or more natural language statements into the logic specification language.

Clause 16. The system of clause 15, wherein the one or more processors are further to generate the translated representation of the one or more natural language statements using one or more large language models tuned to the logic specification language.

Clause 17. The system of clause 15, wherein the one or more processors are further to generate the representation of the one or more logical assessments based at least on processing the translated representation of the one or more natural language statements using the logical reasoning engine.

Clause 18. The system of clause 15, wherein the one or more logical assessments of the one or more natural language statements represent at least one of: a proof or refutation of at least one of the one or more natural language statements, a deduced fact based on at least one of the one or more natural language statements, or a consistency check of at least one of the one or more natural language statements.

Clause 19. The system of clause 15, wherein the one or more processors are further to generate the representation of the one or more logical assessments using one or more prompts generated using retrieval augmented generation and augmented with a representation of content explaining the logic specification language used by the logical reasoning engine.

Clause 20. The system of clause 15, wherein the one or more processors are further to generate, based at least on processing the representation of the one or more logical assessments using one or more large language models, a natural language response based at least on the one or more logical assessments.

Clause 21. The system of clause 15, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

Clause 22. A method comprising obtaining, based at least on processing a translated representation of one or more statements in a particular language using a logical reasoning engine, a representation of one or more logical assessments of the one or more statements.

Clause 23. The method of clause 22, further comprising obtaining, based at least on processing the representation of the one or more logical assessments using one or more large language models, a response in the particular language or at least one other language for the one or more statements.

Clause 24. The method of clause 22 or 23, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

What is claimed is:

1. One or more processors comprising processing circuitry to:
generate, based at least on processing a representation of one or more input statements using one or more large language models (LLMs), one or more logical statements expressed in a logic specification language and representing the one or more input statements;
generate, using a logical reasoning engine corresponding to the logic specification language, a representation of one or more logical assessments of the one or more logical statements;
generate, based at least on processing the representation of the one or more logical assessments using the one or more LLMs, a natural language response for the one or more input statements; and
provide the natural language response as output, wherein the one or more input statements comprise a representation of a query, and the natural language response comprises at least one of: an explanation of, or an answer to a question about, at least a portion of the query.

2. The one or more processors of claim 1, wherein the processing circuitry is further to generate the representation of the one or more input statements based at least on inserting the one or more input statements into one or more template prompts that instruct the one or more LLMs to convert the one or more input statements into the logic specification language.

3. The one or more processors of claim 1, wherein the processing circuitry is further to generate the one or more logical statements using a first large language model of the one or more LLMs, the first large language model tuned to the logic specification language.

4. The one or more processors of claim 1, wherein the logical reasoning engine implements one or more solvers.

5. The one or more processors of claim 1, wherein the one or more logical assessments of the one or more logical statements represent at least one of: a proof or refutation of at least one of the one or more input statements, a deduced fact based on at least one of the one or more input statements, or a consistency check of at least one of the one or more input statements.

6. The one or more processors of claim 1, wherein the processing circuitry is further to generate the representation of the one or more logical assessments using one or more prompts generated using retrieval augmented generation and augmented with a representation of content explaining the logic specification language.

7. The one or more processors of claim 1, wherein the natural language response comprises an explanation of the one or more logical assessments, or an answer to a question associated with the one or more input statements based at least on the one or more logical assessments.

8. The one or more processors of claim 1, wherein the one or more input statements represent a sequence of image data of a video, wherein the natural language response comprises at least one of: an explanation of, or an answer to a question about, at least a portion of the video.

9. The one or more processors of claim 1, wherein the one or more input statements represent a sequence of time-series data, wherein the natural language response comprises at least one of: an explanation of, or an answer to a question about, at least a portion of the time-series data.

10. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

11. A system comprising one or more processors to generate, based at least on processing a translated representation of one or more natural language statements using a logical reasoning engine, a representation of one or more logical assessments expressed in a logic specification language of the one or more natural language statements.

12. The system of claim 11, wherein the one or more processors are further to generate the translated representation of the one or more natural language statements based at least on inserting the one or more natural language statements into one or more template prompts that instruct one or more large language models to convert the one or more natural language statements into the logic specification language.

13. The system of claim 11, wherein the one or more processors are further to generate the translated representation of the one or more natural language statements using one or more large language models tuned to the logic specification language.

14. The system of claim 11, wherein the one or more processors are further to generate the representation of the one or more logical assessments based at least on processing the translated representation of the one or more natural language statements using the logical reasoning engine.

15. The system of claim 11, wherein the one or more logical assessments of the one or more natural language statements represent at least one of: a proof or refutation of at least one of the one or more natural language statements, a deduced fact based on at least one of the one or more natural language statements, or a consistency check of at least one of the one or more natural language statements.

16. The system of claim 11, wherein the one or more processors are further to generate the representation of the one or more logical assessments using one or more prompts generated using retrieval augmented generation and augmented with a representation of content explaining the logic specification language used by the logical reasoning engine.

17. The system of claim 11, wherein the one or more processors are further to generate, based at least on processing the representation of the one or more logical assessments using one or more large language models, a natural language response based at least on the one or more logical assessments.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
obtaining, based at least on processing a translated representation of one or more statements in a particular language using a logical reasoning engine, a representation of one or more logical assessments of the one or more statements; and
obtaining, based at least on processing the representation of the one or more logical assessments using one or more large language models, a response in the particular language or at least one other language for the one or more statements.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center, or
a system implemented at least partially using cloud computing resources.
